(19) United States
(12) Patent Application Publication
(10) Pub. No.: US 2026/0162863 A1
(43) Pub. Date: Jun. 11, 2026

(54) ELECTROMAGNETIC EXCITATION SYSTEM, ELECTROMAGNETIC BRAKE OR CLUTCH AND METHOD FOR PRODUCING AN ELECTROMAGNETIC EXCITATION SYSTEM

(71) Applicant: KENDRION (Villingen) GmbH, Villingen-Schwenningen (DE)

(72) Inventors: Joachim Hubrich, Donaueschingen (DE); Salvatore Quartarone, Tuningen (DE)

(21) Appl. No.: 19/364,555

(22) Filed: Oct. 21, 2025

(30) Foreign Application Priority Data
Nov. 7, 2024 (DE) 102024132451.1

(51) Int. Cl. H01F 7/16; F16D 65/16; F16D 121/20; H01F 7/127

(52) U.S. Cl. CPC H01F 7/1646; F16D 65/16; H01F 7/127; F16D 2121/20

(57) ABSTRACT

An electromagnetic excitation system for an electromagnetic brake or clutch has an electromagnet and a permanent magnet. The electromagnet includes a pot-shaped annular housing about a longitudinal axis with an inner annular portion, an outer annular portion, a bottom portion connecting the inner annular portion and the outer annular portion, and an excitation coil. The excitation coil is inserted into the housing between the inner annular portion and the outer annular portion. A free end of the outer annular portion forms a magnetic pole. The permanent magnet is arranged on a flange on the side facing away from the excitation coil, and the flange is arranged on the side of the excitation coil facing away from the bottom portion and protrudes from the inner annular portion to the outer annular portion, forming an air gap between the flange and the outer annular portion.

The present invention relates to an electromagnetic excitation system having the features of patent claim 1, an electromagnetic brake or clutch having the features of patent claim 9 and a method for producing an electromagnetic brake having the features of patent claim 11.

Electromechanical brakes or clutches in various designs are known from the prior art. In the prior art, generic electromechanical brakes are used, for example, as permanent magnetic brakes or spring-loaded brakes and comprise an electromagnetic excitation system with an electromagnet that can interact with an armature plate to actuate a tribological system of the brake or clutch or to bring it into frictional contact.

The electromagnet typically comprises a pot-shaped annular housing that can be arranged about a longitudinal axis and a shaft, e.g., the shaft of a servo motor. The housing has an inner annular portion and an outer annular portion, and an excitation coil is inserted into the housing between the inner annular portion and the outer annular portion. The free ends of the inner annular portion and the outer annular portion form the magnetic poles of the electromagnet and also the friction surfaces, which is why electromechanical brakes or clutches are also called pole friction brakes or clutches.

In the prior art, permanent magnets are also used as restoring means. When the electromagnet is de-energized, the brake is actuated by the permanent magnets, for example, in order to achieve an emergency stop in the event of a power failure.

Publications US 2023 296 140 A1, DE 20 2004 001 042 U1 and DE 199 46 084 A1 represent further prior art.

Such electromagnetic brakes or clutches have proven themselves in the past, but the known electromagnetic brakes or clutches are relatively long in length and complex to manufacture.

The underlying object of the present invention is therefore to propose a suitably improved electromagnetic excitation system for an electromagnetic brake or clutch, an improved electromagnetic brake or clutch and a method for producing a suitably improved electromagnetic excitation system which eliminates the disadvantages known from the prior art.

These objects are achieved using an electromagnetic excitation system having the features of patent claim 1, an electromagnetic brake or clutch having the features of patent claim 9 and a method for producing an electromagnetic brake having the features of patent claim 11.

Refinements of the invention are specified in the subordinate claims.

The electromagnetic excitation system according to the invention for an electromagnetic brake or clutch having the features of claim 1 has an electromagnet and a permanent magnet.

The electromagnet comprises a pot-shaped annular housing arranged about a longitudinal axis and an excitation coil.

The pot-shaped annular housing has an inner annular portion, an outer annular portion and a bottom portion connecting the inner annular portion and the outer annular portion.

In addition, the excitation coil is inserted into the housing between the inner annular portion and the outer annular portion, and a free end of the outer annular portion forms a magnetic pole.

Furthermore, it is provided that the permanent magnet is arranged on a flange on the side facing away from the excitation coil. The flange may further be arranged on the side of the excitation coil facing away from the bottom portion and may protrude from the inner annular portion to the outer annular portion forming an air gap between the flange and the outer annular portion.

The present invention is based on the idea of proposing an electromagnetic excitation system with a particularly compact design. Unlike, for example, in WO 2006 087 017 A1, the permanent magnet is not sleeve-shaped about the longitudinal axis with radial magnetization, but rather disc-shaped or annular disc-shaped and preferably axially magnetized.

When the electromagnet is de-energized, the field lines in the flange divide into a magnetic circuit through the housing about the excitation coil in a primary flux and a secondary flux through the air gap. In the outer annular portion, the primary flux and the secondary flux combine and flow back to the permanent magnet.

When the electromagnet is energized, the magnetic field of the excitation coil displaces, redirects or neutralizes the magnetic field of the permanent magnet in the region of the magnetic pole and the armature plate. For example, if the electromagnetic excitation system is used in a brake, the brake can be released by energizing the electromagnet. This means that the brake opens and the motor shaft, for example, could rotate again.

In addition, it has proven advantageous for the air gap to act as magnetic resistance and as a secondary air gap in a magnetic circuit of the permanent magnet. In particular, the air gap acts as magnetic resistance and as a secondary air gap in the magnetic circuit of the permanent magnet when the electromagnet is not energized.

A refinement of the present invention provides that the permanent magnet and/or a free end of the inner annular portion is arranged set back in the housing in the longitudinal axis relative to the free end of the outer annular portion or the magnetic pole. In other words, a distance between the permanent magnet and the excitation coil and/or a distance between the free end of the inner annular portion and the excitation coil is smaller than a distance between the magnetic pole and the excitation coil. The aforesaid distances are measured along the longitudinal axis or parallel thereto. Accordingly, when the brake is closed, the armature plate only comes into contact with the magnetic pole or the free end of the outer annular portion. For this reason, the magnetic pole can also be called a single pole.

In addition, it has proven advantageous for the flange to be inserted into the housing. The flange is preferably pressed into the housing and connected to the inner annular portion using a press connection, so that the magnetic resistance between the housing and the flange is kept low. In addition, such a connection can be realized cost-effectively and, in particular, without additional fastening means. By inserting the flange into the housing, the excitation coil is also positioned in the housing in a captive manner and protected from external influences.

Alternatively, the flange can be attached to the housing by gluing, clamping, welding, soldering or by other fastening means such as screws, rivets, or the like. The flange can also be attached to or arranged on the housing using a knurled connection.

Furthermore, it has proven advantageous for the permanent magnet to be a hard ferrite, a samarium-cobalt magnet, a neodymium-iron-boron magnet, a plastic-bonded hard ferrite or a plastic-bonded neodymium-iron-boron magnet. Such magnets are sufficiently strong and have proven themselves in many applications.

According to a refinement of the present invention, the permanent magnet is glued, sprayed or sintered onto the flange. In particular, it is advantageous for the permanent magnet to be sprayed or sintered on, since this preferably means that no additional fastening means are required. For example, plastic-bonded permanent magnets have proven to be advantageous because they can be easily applied to the flange by spraying and no additional fastening means are required.

Furthermore, it has proven advantageous for the housing to be formed in one piece with the inner annular portion, the outer annular portion and the bottom portion. The housing is preferably made of a soft magnetic material that is easily magnetizable. In addition, it has proven advantageous for the flange also to be made of a soft magnetic material that is also easily magnetizable.

A refinement of the present invention provides that the excitation coil comprises a coil carrier and coil windings. The coil windings are preferably wound onto the coil carrier, wherein the coil carrier preferably comprises an electrically insulating material, for example, a plastic, or is made of an electrically insulating material.

Furthermore, it has proven advantageous for the coil carrier to have at least one deformation region which is deformed when the excitation coil is inserted into the housing in order to generate a force fit between the excitation coil and the housing.

The at least one deformation region may comprise at least one elevation or at least one knob.

The at least one deformation region can in particular comprise a wave-shaped portion—preferably with an elevation protruding on the side facing away from the coil windings—wherein the elevation is pressed into the housing when the excitation coil is inserted and causes a deformation of the coil carrier, which leads to a force fit between the excitation coil and the housing.

A further aspect of the present invention relates to an electromagnetic brake or clutch having a previously described electromagnetic excitation system, wherein an armature plate which interacts with the electromagnet and the permanent magnet is arranged and is displaceable in the longitudinal axis.

The present electromagnetic brake or clutch enables a particularly compact design. Unlike, for example, in WO 2006 087 017 A1, the permanent magnet is not formed sleeve-shaped about the longitudinal axis with radial magnetization, but is arranged in a disc-shaped manner on a side facing away from the excitation coil and is axially magnetized.

When the electromagnet is de-energized, the field lines in the flange divide into a magnetic circuit through the housing about the excitation coil in a primary flux and a secondary flux through the air gap. In the outer annular portion, the primary flux and the secondary flux combine and flow together via the magnetic pole into the armature plate and back to the permanent magnet. The reluctance force pulls the armature plate against the magnetic pole, which closes the brake.

When the electromagnet is energized, the excitation coil is supplied with a direct current and the magnetic field of the excitation coil displaces and redirects the magnetic field of the permanent magnet in the region of the magnetic pole and the armature plate. The brake can thus be released. This means that the brake opens and the motor shaft, for example, could rotate again. A further aspect of the present invention relates to a method for producing an electromagnetic excitation system for an electromagnetic brake or clutch, in particular for the electromagnetic brake or clutch described in the foregoing, with an electromagnet and a permanent magnet, having the following method steps:
providing a pot-shaped annular housing having a longitudinal axis, an inner annular portion, an outer annular portion, and a bottom portion connecting the inner annular portion and the outer annular portion;
providing an excitation coil;
inserting the excitation coil into the housing between the inner annular portion and the outer annular portion to form the electromagnet;
providing a flange with a disc-shaped permanent magnet arranged on one end face of the flange; and
arranging the flange on the housing such that the permanent magnet is arranged on the side facing away from the excitation coil and such that the flange protrudes from the inner annular portion to the outer annular portion, forming an air gap between the flange and the outer annular portion.

The method for producing an electromagnetic excitation system, in particular an electromagnetic excitation system for an electromagnetic brake, is distinguished in that it enables simple and cost-effective production of a particularly compact excitation system for an electromagnetic brake. In particular, this method eliminates the need for further fastening means and all components can be connected to one another in a force-fitting manner, preferably in one operation.

A refinement of the method according to the invention provides that, in order to provide the flange, the permanent magnet is glued, sintered or sprayed onto the end face of the flange. For example, a plurality of permanent magnets can be glued onto the end face or a plastic-bonded magnet can be sprayed onto the end face in a thin layer, wherein the magnetization preferably takes place axially, i.e., along the longitudinal axis.

The permanent magnet is preferably disc-shaped, wherein even more preferably the permanent magnet has a thickness in the longitudinal axis which is smaller than a thickness of the flange.

According to a refinement, the permanent magnet is preferably not magnetized until after it has been arranged on the end face of the flange.

A refinement of the present invention provides that the flange is connected to the housing. For example, the flange can be attached to the housing by gluing, clamping, welding, soldering or by other fastening means such as screws, rivets, or the like.

In particular, it is preferred for the flange to be inserted into the housing.

When inserting the flange, the flange is arranged between the inner annular portion and the outer annular portion in the housing, forming the air gap. The flange with the permanent magnet is inserted into the housing until the permanent magnet and/or a free end of the inner annular portion is set back in the longitudinal axis relative to the magnetic pole. In other words, a distance in the longitudinal axis between the permanent magnet and the excitation coil and/or a distance between one free end of the inner annular portion and the excitation coil is smaller than a distance between the magnetic pole and the excitation coil.

For example, if the electromagnetic excitation system is used to form a brake or clutch with an armature plate that interacts with the electromagnet and the permanent magnet, the armature plate only comes into contact with the magnetic pole—that is, at the free end of the outer annular portion of the housing when the brake or clutch is closed—and not with the permanent magnet.

The flange is preferably pressed into the housing, wherein even more preferably a press connection is produced between the flange and the housing, in particular the inner annular portion, so that the flange is arranged particularly securely on the housing.

A refinement of the present invention provides that when the excitation coil is inserted, the excitation coil is connected to the housing in a force fit. For example, the inner annular portion, the outer annular portion and/or the excitation coil can have suitable surface structures, such as, e.g., ribbing, by means of which the excitation coil can be arranged in the housing in a force fit.

In addition, it has proven advantageous for the excitation coil to comprise a coil carrier and coil windings. The coil carrier is preferably made of an electrically insulating material such as, e.g., plastic and the coil windings are arranged or wound on the coil carrier. Furthermore, it is preferred for the coil carrier to have at least one deformation region which is deformed, when the excitation coil is inserted into the housing, such that the excitation coil is arranged in the housing in a force fit.

The at least one deformation region can comprise, for example, at least one elevation or at least one knob protruding on the side facing away from the coil windings, wherein the at least one elevation or the at least one knob is deformed or pressed in when the excitation coil is inserted into the housing and causes a deformation of the coil carrier, which leads to a force fit between the excitation coil and the housing.

Furthermore, it is advantageous for the force fit between the excitation coil and the housing to be established during insertion, even more preferably when the flange is pressed in. For example, the excitation coil can initially be inserted loosely into the housing. The force fit between the excitation coil and the housing occurs when the flange is pressed in, in that the flange presses the excitation coil against the bottom portion and the excitation coil or the at least one deformation region in the housing is deformed such that the excitation coil is arranged in the housing in a force fit.

One exemplary embodiment will be described in detail below with reference to the accompanying drawings. They show:

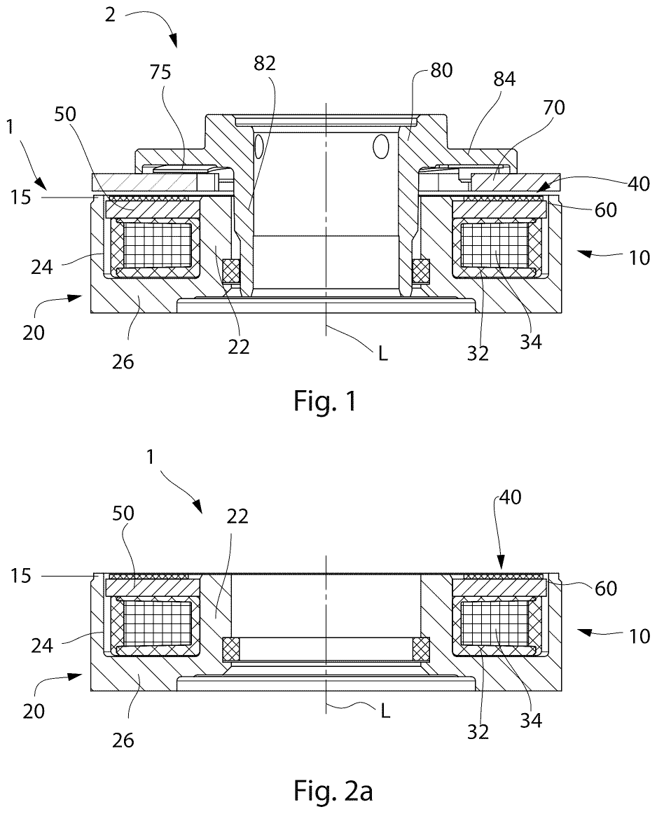

FIG. 1 is a sectional view of a released electromagnetic brake with an excitation system and an armature;

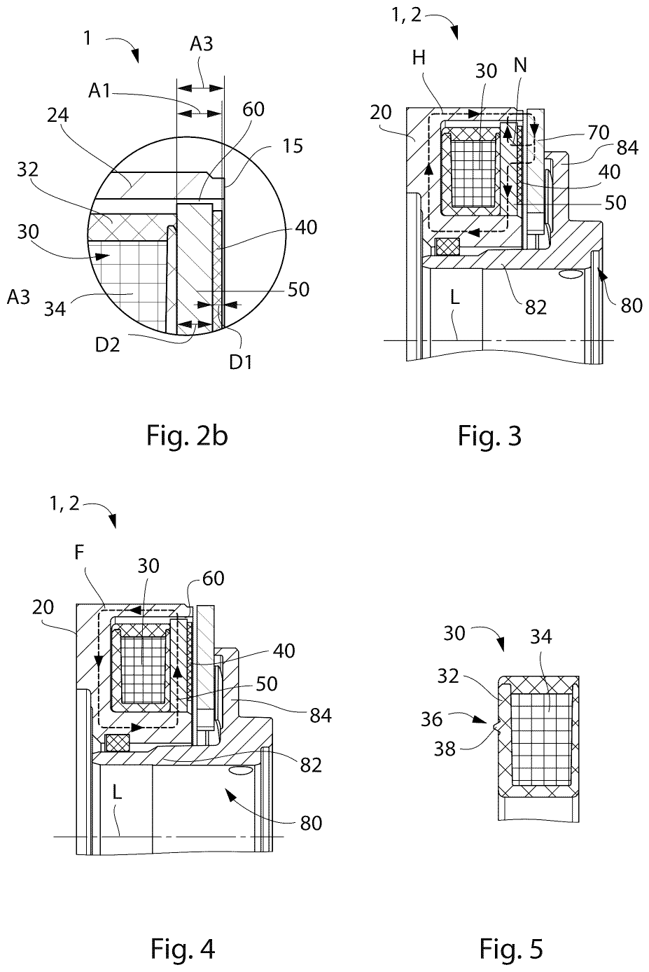

FIG. 2a shows the electromagnetic excitation system of the electromagnetic brake according to FIG. 1;

FIG. 2b shows a detailed view of the electromagnetic excitation system according to FIG. 2a;

FIG. 3 is a schematic detailed view of the magnetic flux in the released electromagnetic brake according to FIG. 1;

FIG. 4 is a schematic detailed view of the magnetic flux in the released electromagnetic brake; and,

FIG. 5 shows a detailed view of an excitation coil of the excitation system according to FIGS. 1-4 before insertion into the housing.

Identical or functionally identical parts or features are identified by the same reference symbols in the following detailed description of the figures. Likewise, not all identical or functionally identical parts or features in the figures are provided with a reference number.

FIG. 1 shows an exemplary embodiment of an electromagnetic brake 2 with an electromagnetic excitation system 1.

The electromagnetic excitation system 1 of the electromagnetic brake 2 according to FIG. 1 is shown in detail in FIG. 2a and comprises an electromagnet 10 and a permanent magnet 40.

The electromagnet 10 comprises a housing 20 which is pot-shaped and annular about a longitudinal axis L. The housing 20 is preferably designed to be substantially rotationally symmetrical, wherein the longitudinal axis L forms the axis of symmetry.

The pot-shaped annular housing 20 can be made of a soft magnetic material and has an inner annular portion 22, an outer annular portion 24 and a bottom portion 26 connecting the inner annular portion 22 and the outer annular portion 24.

The inner annular portion 22 and the outer annular portion 24 are connected at one end to the bottom portion 26 and protrude from the bottom portion 26 and each has a free end at the other end. In other words, the housing 20 has an axial annular groove for receiving the excitation coil 30.

The free end of the outer annular portion 24 forms a magnetic pole 15.

The excitation coil 30 is inserted into the housing 20, wherein the excitation coil 30 is inserted into the housing 20 between the inner annular portion 22 and the outer annular portion 24, that is, in the axial annular groove.

The excitation coil 30 comprises a coil carrier 32 and coil windings 34. The coil windings 34 are preferably wound on the coil carrier 32, wherein the coil carrier 32 preferably comprises an electrically insulating material, for example, plastic, or is made of an electrically insulating material.

The coil carrier 32 can have at least one deformation region 36 (see FIG. 5) which deforms when the excitation coil 30 is inserted into the housing 20 and creates a force fit between the excitation coil 30 and the housing 20, in particular the inner annular portion 22 and/or the outer annular portion 24.

The at least one deformation region 36 comprises a portion which is wave-shaped in cross-section and has at least one projecting elevation 38 or one or a plurality of knobs. The elevation 38 is pressed into the housing 20 when the excitation coil 30 is inserted and causes a deformation of the coil carrier 32, which leads to the force fit between the excitation coil 30 and the housing 20.

Furthermore, the electromagnetic excitation system 1 comprises a flange 50, wherein the flange 50 is preferably made of a soft magnetic material. The permanent magnet 40 is preferably securely arranged on one of the end faces of the flange 50. The flange 50 and the permanent magnet 40 can thus be firmly connected to one another and form a unit.

The permanent magnet 40 is preferably disc-shaped, more precisely is an annular disc, wherein a thickness D1 of the permanent magnet 40 is preferably smaller and even more preferably many times smaller than a thickness D2 of the flange 50.

The permanent magnet 40 is axially magnetized, which means that the annular disc-shaped permanent magnet 40 is magnetized through its thickness and its poles lie on the flat circular surfaces.

The permanent magnet 40 may be a hard ferrite, a samarium-cobalt magnet, a neodymium-iron-boron magnet, a plastic-bonded hard ferrite, or a plastic-bonded neodymium-iron-boron magnet and may be glued, sprayed, or sintered onto the flange 50.

The flange 50 is inserted into the housing 20, wherein the permanent magnet 40 is arranged on the side facing away from the excitation coil 30.

In particular, it can be seen from the attached figures that the flange 50 is arranged on the side of the excitation coil 30 facing away from the bottom portion 26 and projects from the inner annular portion 22 to the outer annular portion 24, forming an air gap 60 between the flange 50 and the outer annular portion 24.

In the simplest case, the flange 50 can be pressed into the housing 20 or onto the inner annular portion 22, so that the flange 50 is securely connected to the inner annular portion 22. Furthermore, the connection does not have any significant magnetic resistance.

Alternatively, the flange 50 can be attached to the housing 20 by gluing, clamping, welding, soldering or by other fastening means such as screws, rivets, or the like. The flange 50 can also be attached to or arranged on the housing 20 using a knurled connection.

The air gap 60 has increased magnetic resistance and can act as magnetic resistance and as a secondary air gap in the magnetic system, which will be described later.

The permanent magnet 40 and the flange 50 are preferably arranged set back in the longitudinal axis L relative to the free end of the outer annular portion 24 or the magnetic pole 15 in the housing 20.

The free end of the inner annular portion 22 can also be arranged set back in the longitudinal axis L relative to the free end of the outer annular portion 24 or the magnetic pole 15 in the longitudinal axis L.

In other words, as shown in FIG. 2b, a first distance A1, measured between the permanent magnet 40 and the excitation coil 30, and/or a second distance A2 (not shown) between the free end of the inner annular portion 22 and the excitation coil 30, may be smaller than a third distance A3 between the magnetic pole 15 and the excitation coil 30.

Furthermore, the electromagnetic brake 2 according to FIG. 1 comprises an armature plate 70, which interacts in a known manner with the electromagnet 10 and the permanent magnet 40. The armature plate 70 is displaceable along the longitudinal axis L.

The armature plate 70 is further arranged on a flange hub 80, wherein the armature plate 70 is connected to the flange hub 80, via spring means 75, for example, using which the armature plate 70 is displaceable in the longitudinal axis L.

The flange hub 80 has a hub portion 82 and a flange portion 84 and can be connected in a known manner, for example, to a motor shaft of a synchronous machine.

FIGS. 3 and 4 schematically show the magnetic system of the permanent magnet brake with the electromagnetic excitation system 1.

Under the influence of the permanent magnetic field of the permanent magnet 40, the armature plate 70 is pressed against the magnetic pole 15 in a force fit. The resulting frictional force generates the braking torque.

In this state, the electromagnet 10 of the excitation system 1 is de-energized and the magnetic flux of the permanent magnet 40 divides into a primary flux H and a secondary flux N in the flange.

The primary flux H flows from the flange 50 through the housing 20 about the excitation coil 30, that is, from the inner annular portion 22 through the bottom portion 26 to the outer annular portion 24.

The secondary flow N flows through the flange 50 and across the air gap 60 into the outer annular portion 24.

In the outer annular portion 24, the primary flux H and the secondary flux N combine and flow together via the magnetic pole 15 through the armature plate 70 and the permanent magnet 40.

The reluctance force pulls the armature plate 70 against the magnetic pole 15, thereby closing the electromagnetic brake 2.

To cancel the braking effect—that is, to release the electromagnetic brake 2 the permanent magnetic field acting on the armature plate 70 is displaced, redirected, neutralized by an opposing electromagnetic field, as shown in FIG. 4, when a direct voltage is applied to the excitation coil 30, and the electromagnetic brake 1 opens in that the spring means 75 move the armature plate 70 along the longitudinal axis L away from the excitation system 1 and pull it towards the flange portion 84 of the flange hub 80. The magnetic flux F flows through the housing 20, the flange 50 and the air gap 60.

The electromagnetic excitation system 1 for the electromagnetic brake 2 or clutch can be manufactured particularly easily and cost-effectively.

First, the pot-shaped annular housing 20, the excitation coil 30 and the flange 50 with the annular disc-shaped permanent magnet 40 arranged on the end face of the flange 50 are provided. The excitation coil 30 is then inserted into the housing 20 between the inner annular portion 22 and the outer annular portion 24 to form the electromagnet.

Finally, the flange 50 is arranged on the housing 20 such that the permanent magnet 40 is arranged on the side facing away from the excitation coil 30 and the flange 50 protrudes from the inner annular portion 22 to the outer annular portion 24, forming an air gap 60 between the flange 50 and the outer annular portion 24.

The permanent magnet 40 can preferably be glued, sintered or sprayed onto the end face of the flange 50 before the flange 50 is arranged on the housing 20. For this purpose, for example, a plurality of permanent magnets can be glued to the end face or may be sprayed as a plastic-bonded magnets onto the end face in a thin layer, wherein the magnetization occurs axially, i.e., along the longitudinal axis L.

The arrangement of the flange 50 on the housing 20 can be carried out by pressing the flange 50 into the housing 20, wherein the flange 50 is preferably pressed onto the inner annular portion 22.

The flange 50 with the permanent magnet 40 is pushed into the housing 20 until the permanent magnet 40 and the flange 50 are arranged set back in the longitudinal axis L relative to the magnetic pole 15.

When inserting the excitation coil 30, the excitation coil 30 can be connected to the housing 20 in a force fit. For this purpose, for example, the deformation region 36 can be deformed when the excitation coil 30 is inserted into the housing 20, wherein this deformation can occur when pressing in or inserting the flange 50.

### LIST OF REFERENCE SYMBOLS

1 Excitation system
2 Brake
10 Electromagnet
15 Magnetic pole
20 Housing
22 Inner annular portion
24 Outer annular portion
26 Bottom portion
30 Excitation coil
32 Coil carrier
34 Coil windings
36 Deformation region
38 Elevation
40 Permanent magnet
50 Flange
60 Air gap
70 Armature plate
75 Spring means
80 Flange hub
82 Hub portion
84 Flange portion
A1 First distance
A2 Second distance
A3 Third distance
F Magnetic flux
H Primary flux
L Longitudinal axis
N Secondary flux

1. An electromagnetic excitation system (1) for an electromagnetic brake (2) or clutch, having an electromagnet (10) and a permanent magnet (40),
wherein the electromagnet (10) comprises a pot-shaped annular housing (20) about a longitudinal axis (L) with an inner annular portion (22), an outer annular portion (24), a bottom portion (26) connecting the inner annular portion (22) and the outer annular portion (24), and an excitation coil (30);
wherein the excitation coil (30) is inserted into the housing (20) between the inner annular portion (22) and the outer annular portion (24), and wherein a free end of the outer annular portion (24) forms a magnetic pole (15);
wherein the permanent magnet (40) is arranged on a flange (50) on the side facing away from the excitation coil (30); and
wherein the flange (50) is arranged on the side of the excitation coil (30) facing away from the bottom portion (26) and protrudes from the inner annular portion (22) to the outer annular portion (24) forming an air gap (60) between the flange (50) and the outer annular portion (24).

2. The electromagnetic excitation system (1) according to claim 1, characterized in that the permanent magnet (40) and/or a free end of the inner annular portion (22) is arranged set back in the longitudinal axis (L) relative to the magnetic pole (15).

3. The electromagnetic excitation system (1) according to claim 1, characterized in that the flange (50) is pressed into the housing (20).

4. The electromagnetic excitation system (1) according to claim 1, characterized in that the permanent magnet (40) is a hard ferrite, a samarium-cobalt magnet, a neodymium-iron-boron magnet, a plastic-bonded hard ferrite or a plastic-bonded neodymium-iron-boron magnet.

5. The electromagnetic excitation system (1) according to claim 1, characterized in that the permanent magnet (40) is glued, sprayed or sintered onto the flange.

6. The electromagnetic excitation system (1) according to claim 1, characterized in that the air gap (60) acts as magnetic resistance and as a secondary air gap in a magnetic circuit of the permanent magnet (40).

7. The electromagnetic excitation system (1) according to claim 1, characterized in that the housing (20) is formed in one piece with the inner annular portion (22), the outer annular portion (24) and the bottom portion (26).

8. The electromagnetic excitation system (1) according to claim 1, characterized in that the excitation coil (30) comprises a coil carrier (32) and coil windings (34), and in that the coil carrier (32) has at least one deformation region (36) which is deformed when the excitation coil (30) is inserted into the housing (20) in order to produce a force fit between the excitation coil (30) and the housing (20).

9. An electromagnetic brake (2) having an electromagnetic excitation system (1) according to claim 1, characterized in that an armature plate (70) which interacts with the electromagnet (10) and the permanent magnet (40) is provided and is displaceable along the longitudinal axis (L).

10. The electromagnetic brake (2) according to claim 9, characterized in that the armature plate (70) is arranged on a flange hub (80) so as to be displaceable in the longitudinal axis (L).

11. A method for producing an electromagnetic excitation system (1) for an electromagnetic brake (2), in particular an electromagnetic excitation system (1) according to claim 1 and/or for an electromagnetic brake (2) having the following method steps:
providing an electromagnet (10) having a pot-shaped annular housing (20) with an inner annular portion (22) and an outer annular portion (24) and with an excitation coil (30);
providing an excitation coil (30);
Inserting the excitation coil (30) into the housing (20) between the inner annular portion (22) and the outer annular portion (24);
providing a flange (50) having a permanent magnet (40) arranged on the flange (50); and
arranging the flange (50) on the housing (20) such that the permanent magnet

(40) is arranged on the side facing away from the excitation coil and such that the flange (50) protrudes from the inner annular portion (22) to the outer annular portion (24), forming an air gap (60) between the flange (50) and the outer annular portion (24).

12. The method according to claim 11, characterized in that the permanent magnet (40) is glued, sprayed or sintered onto the flange (50).

13. The method according to claim 11, characterized in that the flange (50) is inserted, in particular pressed, into the housing (20).

14. The method according to claim 11, characterized in that the excitation coil (30) is arranged in the housing (20) in a force fit when inserted into the housing (20).

15. The method according to claim 11, characterized in that the excitation coil (30) comprises a coil carrier (32) and coil windings (34), and in that the coil carrier (32) has at least one deformation region (36) which is deformed when the excitation coil (30) is inserted into the housing (20) in order to arrange the excitation coil (30) in the housing (20) in a force fit.
